(19) United States
(12) Patent Application Publication
(10) Pub. No.: US 2005/0169231 A1
(43) Pub. Date: Aug. 4, 2005

(54) Method and system for detecting pending transmissions in a wireless data network

(75) Inventor: Richard Thomas Bennett, Vancouver, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/876,935

(22) Filed: Jun. 24, 2004

Related U.S. Application Data
(60) Provisional application No. 60/541,886, filed on Feb. 3, 2004.

(51) Int. Cl. H04B 7/212

(52) U.S. Cl. 370/347

(57) ABSTRACT

A method for detecting pending transmissions in a wireless data network using a medium access control protocol includes defining bandwidth reservation parameters for inclusion in each packet transmitted on the network; providing information about existing reservation of time slots to stations on the network; providing a reservation preamble in each packet transmitted over the network; announcing a reserved time slot by identifying the duration and period of recurrence of a reservation; and allowing stations in the network to transmit packets in time slots identified as being unreserved. A system for detecting pending transmissions in a wireless data network using a medium access control protocol includes a bandwidth reservation parameters for inclusion in each packet transmitted on the network; providing information about existing reservation of time slots to stations on the network; a reservation preamble located in each packet transmitted over the network; announcing a reserved time slot by identifying the duration and period of recurrence of a reservation; and allowing stations in the network to transmit packets in time slots identified as being unreserved.

### RELATED APPLICATION

This application is related to U.S. Provisional U.S. Patent Application Ser. No. 60/541,886, filed Feb. 3, 2004, for Decentralized bandwidth reservation mechanism for wireless networks, and claims priority therefrom.

### FIELD OF THE INVENTION

This invention relates to wireless local area networks (WLANs) and to wireless personal area networks (WPANs), and specifically to audio/visual (A/V) streaming over ultra-wide band (UWB) home networks.

### BACKGROUND OF THE INVENTION

Existing wireless protocols generally manage time division multiple access (TDMA) time slots by means of a central controller, which has total control over all the stations in a network, or at least in a significant portion of a network. The central controller has no reason to advise stations of bandwidth allocations in an interval smaller than a Superframe, the period of recurrence common to the all stations under its control. In alternative approaches, pairs of controllers negotiate with each other for intervals which are allocated in “ping-pong” fashion, according to a fixed interval negotiated between the controllers.

These networks enable-digital data to be communicated between cooperating nodes over distances of one to three-hundred feet, with limited support for Quality of Service (QoS) and mobility. They also generally radiate from a central controller, which provides a variety of network management and control functions.

Neither of these approaches works well for low-power, limited distance networks, as, in such networks, the assumption cannot be made that every station is capable of receiving reservation information from a central controller.

U.S. Pat. No. 5,231,634 for Medium access protocol for wireless LANs, to Giles et al., granted Jul. 27, 1993, describes a method of reserving single period of time for a data transmission between two stations (or nodes) in a wireless network relying on an exchange of communications parameters. The method transmits reservation parameters once at the beginning of the transfer of a limited series of data packets, which is similar to EP0653865, except that it uses one less exchange to end a reservation.

EP 0653865 A2, for Medium access control protocol for wireless communication, of Chen et al., granted Sep. 5, 2001, describes a method of reserving single period of time for a data transmission between two stations (or nodes) in a wireless network relying on an exchange of communications parameters. The method transmits reservation parameters once at the beginning of the transfer of a series of data packets.

WO 02/03693 A1, for Advanced set top terminal having a video call feature, of Asmussen, published Jan. 10, 2002, describes a system for allocating satellite bandwidth among groups of audio video consumers under the control of a central station. The reference provides for display of channel reservations in human-readable form after a decision has been made at the central station to allocate them.

### SUMMARY OF THE INVENTION

A method for detecting pending transmissions in a wireless data network using a medium access control protocol includes defining bandwidth reservation parameters for inclusion in each packet transmitted on the network; providing information about existing reservation of time slots to stations on the network; providing a reservation preamble in each packet transmitted over the network; announcing a reserved time slot by identifying the duration and period of recurrence of a reservation; and allowing stations in the network to transmit packets in time slots identified as being unreserved.

A system for detecting pending transmissions in a wireless data network using a medium access control protocol includes a bandwidth reservation parameters for inclusion in each packet transmitted on the network; providing information about existing reservation of time slots to stations on the network; a reservation preamble located in each packet transmitted over the network; announcing a reserved time slot by identifying the duration and period of recurrence of a reservation; and allowing stations in the network to transmit packets in time slots identified as being unreserved.

An object of the invention is to provide for advertisement a TDMA channel allocation for a recurring pattern of time slots over a period of time, in each data packet is transmitted as part of the channel allocation.

Another object of the invention is to provide wireless stations having limited power, mobile nodes, and nodes operating in challenging conditions to achieve QoS without unrealistic reliance on central controllers.

A further object of the method of the invention is to eliminate the Superframe structure common to IEEE 802.15.3 and many other approaches.

Another object of the invention is to replace the common Superframe structure with an implicit Superframe which provides a common time base to all reservations.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

### DETAILED DESCRIPTION OF THE PREFERRED EMBODIMENTS

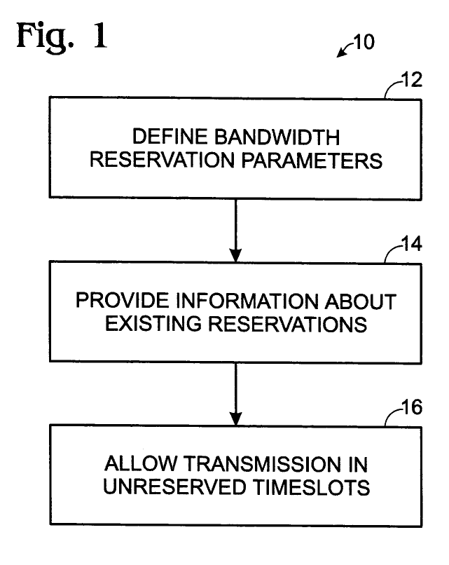

This invention advertises a time divisional multiple access (TDMA) channel allocation made for a recurring pattern of time slots over a period of time in each data packet transmitted as part of the allocation. It enables wireless stations with limited power, mobile nodes, and nodes operating in challenging conditions to achieve Quality of Service (QoS) without unrealistic reliance on central controllers. It dispenses with the Superframe structure, common to IEEE 802.15.3 and many other approaches, replacing it with an implicit Superframe serving simply as a common time base to all reservations. Referring to FIG. 1, the method of the invention is depicted generally at 10, and defines bandwidth reservation parameters 12, and does not define any particular medium access control (MAC) protocol or any of the conventional methods of using the bandwidth reservation parameters, thus, may be used with any number of MAC protocols, regardless of whether the specific MAC protocol uses Superframe constructs or Superframes, e.g. IEEE 802.15.3, Superframes, while other MAC protocols may not use the Superframe concept, e.g., IEEE 802.11, or may use an implicit Superframe concept, such as a system which makes reservations on a Superframe-by-Superframe basis, but wherein the Superframes do not have any explicit beginning or ending indicia or messages.

The protocol of the method of the invention enables reservations to be displayed in machine-readable form, whether they relate to single packets or to sessions involving a series of network accesses, and it allows for the interleaving of multiple sessions over one another without corruption, collision, or loss of data. It also enables stations not present at the time reservations were made to be aware of the state of all reservations in an area. In its preferred embodiment, the method of the invention includes a network using a multiple-way handshake to secure a unique reservation of time on a recurring basis in an ad-hoc network.

Any truly ad-hoc, mobile, and free-topology network requires a mechanism of the type disclosed herein in order to convey the knowledge of reservations to all pertinent nodes, so it's actually fundamental to a new generation of wireless protocols.

Definitions:

Node: a single transmitter and receiver in a network.
Packet: a sequence of data transmitted one time in one Time Slot.
Preamble: a sequence of data transmitted at the start of a Packet in a common format easily-readable by other stations.
Quality of Service: a time-bounded network access guarantee.
Reservation map: a sequence of data identifying the particular Time Slots in the Superframe occupied by a reservation or by a reserver.
Superframe: a period of time bounding a bandwidth reservation, such that a reservation occupies a given time in each Superframe recurring at a given interval, or on every Superframe. For present purposes, a reservation occupies one or more consecutive time slots in each Superframe or in each Superframe occurring in a sequence of Superframes, such as 1 in 2, 1 in 3, 1 in 4, and so on.
Time Slot: the minimum portion of a Superframe that can be allocated or reserved by a station.

The method of the invention is both an input to and an output from the process of reserving a portion of bandwidth in an omni-directional network, such as WLAN or a WPAN. For purposes of this invention, the process of bandwidth reservation is a black box function that may be performed in a variety of ways, bounded only by the requirement that it should be reasonably reliable at preventing over-booking of bandwidth reservations.

As an input to the reservation device, this invention communicates information about existing reservations 14, which must be avoided in the assignment of new reservations. The reservation device cannot be assumed to have knowledge of existing reservations, as the reservation device may be distributed across many nodes, it may be mobile, it may operate on a limited duty cycle, and it may be a new addition to the network. Consequently, a robust reservation mechanism must be capable of learning the state of existing reservations in a network, the service this invention provides.

This invention advertises, or announces, reservation parameters in a preamble in each data packet sent in each time slot in each Superframe. The announcement serves to generalize the existence of a reservation by asserting its duration in time slots and its period of recurrence, to wit:

TABLE 1
Reservation Preamble Format

| | | | | |
|---|---|---|---|---|
| Sync | Superframe | Number of Slots | Frequency of | Sync |
| | duration | | Recurrence | |

Sync: any data pattern required by the network technology to recognize the existence of the preamble; may be empty.
Superframe duration: the length of time until a new reservation period begins, according to a time base agreed-upon by the network. No additional Superframe information is actually transmitted over the medium.
Number of Slots: the number of consecutive time slots allocated by this reservation, which must be one or more; the value 0 is reserved for single use time slots that aren't part of a recurring reservation.
Frequency of Recurrence: the number of Superframe periods that must elapse before the reservation becomes active again.
   Stations transmit during time slots which are not identified a being reserved.

Following are a set of alternate formats, each of which is a subset of the primary format.

TABLE 2
Alternate Preamble Format 1

| | | | |
|---|---|---|---|
| Sync | Number of Slots | Frequency of | Sync |
| | | Recurrence | |

The fields in this preamble have the same significance as in the Primary format.

TABLE 3
Alternate Preamble Format 2

| | | |
|---|---|---|
| Sync | Frequency of Recurrence | Sync |

The fields in this preamble have the same significance as in the Primary format.

TABLE 4
Alternate Preamble Format 3

| | | |
|---|---|---|
| Sync | Number of Slots | Sync |

The fields in this preamble have the same significance as in the Primary format.

TABLE 5
Alternate Preamble Format 4

| | | |
|---|---|---|
| Sync | Superframe Duration | Sync |

The fields in this preamble have the same significance as in the Primary format.

Thus, a method and system for detecting pending transmissions in a wireless data network has been disclosed. It will be appreciated that further variations and modifications thereof may be made within the scope of the invention as defined in the appended claims.

1. A method for detecting pending transmissions in a wireless data network using a medium access control protocol, comprising:
defining bandwidth reservation parameters for inclusion in each packet transmitted on the network;
providing information about existing reservation of time slots to stations on the network; and
allowing stations in the network to transmit packets in time slots identified as being unreserved.

2. The method of claim 1 which includes providing a reservation preamble in each packet transmitted over the network.

3. The method of claim 2 wherein the reservation preamble includes a sync portion, a Superframe duration portion, a portion identifying the number of slots, a frequency of recurrence portion.

4. The method of claim 2 wherein the reservation preamble includes a sync portion, a portion identifying the number of slots, and a frequency of recurrence portion.

5. The method of claim 2 wherein the reservation preamble includes a sync portion, and a frequency of recurrence portion.

6. The method of claim 2 wherein the reservation preamble includes a sync portion, and a portion identifying the number of slots.

7. The method of claim 2 wherein the reservation preamble includes a sync portion, and a Superframe duration portion.

8. The method of claim 1 which includes announcing a reserved time slot by identifying the duration and period of recurrence of a reservation.

9. A method for detecting pending transmissions in a wireless data network using a medium access control protocol, comprising:
defining bandwidth reservation parameters for inclusion in each packet transmitted on the network;
providing information about existing reservation of time slots to stations on the network;
providing a reservation preamble in each packet transmitted over the network;
announcing a reserved time slot by identifying the duration and period of recurrence of a reservation; and
allowing stations in the network to transmit packets in time slots identified as being unreserved.

10. The method of claim 9 wherein the reservation preamble includes a sync portion, a Superframe duration portion, a portion identifying the number of slots, a frequency of recurrence portion.

11. The method of claim 9 wherein the reservation preamble includes a sync portion, a portion identifying the number of slots, and a frequency of recurrence portion.

12. The method of claim 9 wherein the reservation preamble includes a sync portion, and a frequency of recurrence portion.

13. The method of claim 9 wherein the reservation preamble includes a sync portion, and a portion identifying the number of slots.

14. The method of claim 9 wherein the reservation preamble includes a sync portion, and a Superframe duration portion.

15. A system for detecting pending transmissions in a wireless data network using a medium access control protocol, comprising:
a bandwidth reservation parameters for inclusion in each packet transmitted on the network;
providing information about existing reservation of time slots to stations on the network;
a reservation preamble located in each packet transmitted over the network;
announcing a reserved time slot by identifying the duration and period of recurrence of a reservation; and
allowing stations in the network to transmit packets in time slots identified as being unreserved.

16. The system of claim 15 wherein the reservation preamble includes a sync portion, a Superframe duration portion, a portion identifying the number of slots, a frequency of recurrence portion.

17. The method of claim 15 wherein the reservation preamble includes a sync portion, a portion identifying the number of slots, and a frequency of recurrence portion.

18. The method of claim 15 wherein the reservation preamble includes a sync portion, and a frequency of recurrence portion.

19. The method of claim 15 wherein the reservation preamble includes a sync portion, and a portion identifying the number of slots.

20. The method of claim 15 wherein the reservation preamble includes a sync portion, and a Superframe duration portion.
